(19) United States
(12) Patent Application Publication
(10) Pub. No.: US 2006/0090613 A1
(43) Pub. Date: May 4, 2006

(54) Pivotal retaining device of hand tool

(76) Inventor: Chih-Ching Hsieh, Taichung Hsien (TW)

Correspondence Address: Chih-Ching HSIEH, 235 Chung - Ho, Box 8-24, Taichung Hsien, Taipei, TW

(21) Appl. No.: 10/978,751

(22) Filed: Nov. 2, 2004

(51) Int. Cl. B25B 23/16; B25B 7/00

(52) U.S. Cl. 81/177.8; 81/177.9; 81/415

(57) ABSTRACT

The pivotal retaining device comprises; a pivotal portion having at least one first pivotal blocks at a distal end of a clamping portion and at least one second pivotal block at a front end of a handle portion; each first pivotal block having a respective first through hole. Each second pivotal block has a respective screw hole positioned corresponding to the through hole; each second pivotal block having a positioning hole which communicates into the screw hole; a pin inserting into the positioning hole; at least one retaining shaft; each retaining shaft inserting through the through hole and the positioning hole so as to fix the first pivotal block to the second pivotal block. Each retaining shaft has an insertion hole. The pin passing through the positioning hole further inserts through the insertion hole; thus the first pivotal block being firmly secured to the respective second pivotal block.

### FIELD OF THE INVENTION

The present invention relates to handle tools, and particularly to a pivotal retaining device of a hand tool, wherein by the pins in the insertion holes of the thread portions, the retaining shafts will not rotate with respect to the tool body to be released. Thus, the retaining shafts will not fall out.

### BACKGROUND OF THE INVENTION

In the prior art, the pliers like tool has a handle portion and a clamping portion. The clamping portion and the handle portion are fixed and are not moveable with respect to one another. However this will induce disease of carpal tunnel syndrome to the user's wrist. Moreover, the prior art is not suitable to be used in a narrow space or a limited space.

Currently, a new design is developed. In that, a pivotal portion is installed between the clamping portion and the handle portion. Thereby the handle portion is rotatable with respect to the clamping portion. The pliers can be used to various environments and the wrist is protected. In this prior art, the pivotal portion has a threaded pivotal shaft. When the clamping portion rotates with respect to the handle portion so as to adjust the form the tool the pivotal shaft is very possible to be driven so the pivotal shaft is released therefrom or even falls out or destroyed as the tool is used for a longer time period so as to short the lifetime or even effect the quality of the products.

### SUMMARY OF THE INVENTION

Accordingly, the primary object of the present invention is to provide a pivotal retaining device of a hand tool, wherein by the pins in the insertion holes of the thread portions, the retaining shafts will not rotate with respect to the tool body to be released. Thus, the retaining shafts will not fall out.

To achieve above objects, the present invention provides a pivotal retaining device which comprises; a pivotal portion having at least one first pivotal blocks at a distal end of a clamping portion and at least one second pivotal block at a front end of a handle portion; each first pivotal block having a respective first through hole. Each second pivotal block has a respective screw hole positioned corresponding to the through hole. Each second pivotal block has a positioning hole which communicates into the screw hole; a pin inserting into the positioning hole; at least one retaining shaft; each retaining shaft inserting through the through hole and the positioning hole so as to fix the first pivotal block to the second pivotal block. Each retaining shaft has an insertion hole. The pin passing through the positioning hole further inserts through the insertion hole; thus the first pivotal block being firmly secured to the respective second pivotal block.

The various objects and advantages of the present invention will be more readily understood from the following detailed description when read in conjunction with the appended drawing.

### BRIEF DESCRIPTION OF THE DRAWINGS

FIG. 1 is an exploded perspective view of the pivotal retaining device of a hand tool of the present invention.

FIG. 2 is a partial perspective view of the pivotal retaining device of a hand tool of the present invention.

FIG. 3 is a partial cross sectional view of the pivotal retaining device of a hand tool of the present invention.

FIG. 4 is a partial enlarged cross sectional view of the pivotal retaining device of a hand tool of the present invention.

FIG. 5 is a perspective view the second embodiment of the present invention.

FIG. 6 is a partial enlarged cross sectional view of the second embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

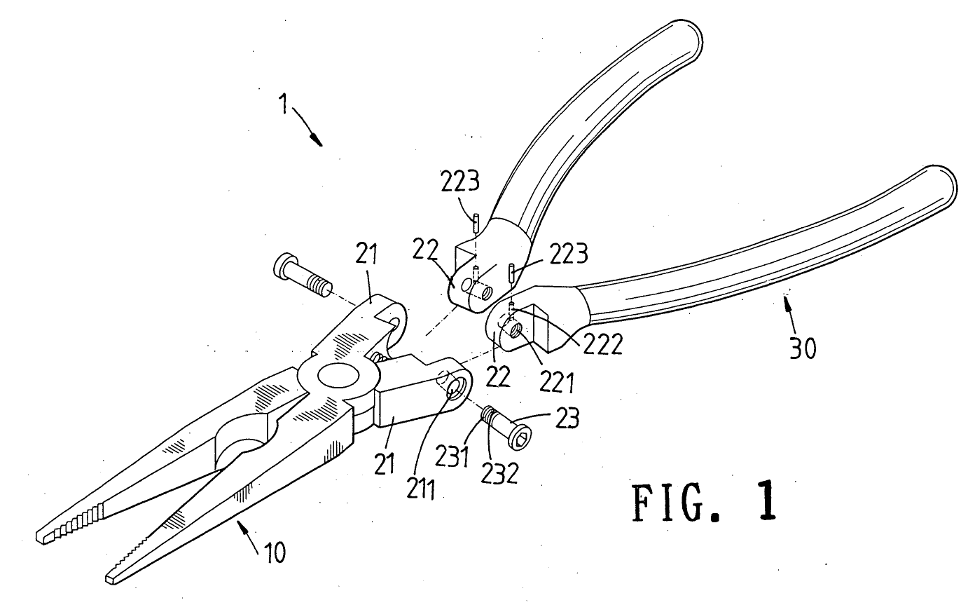

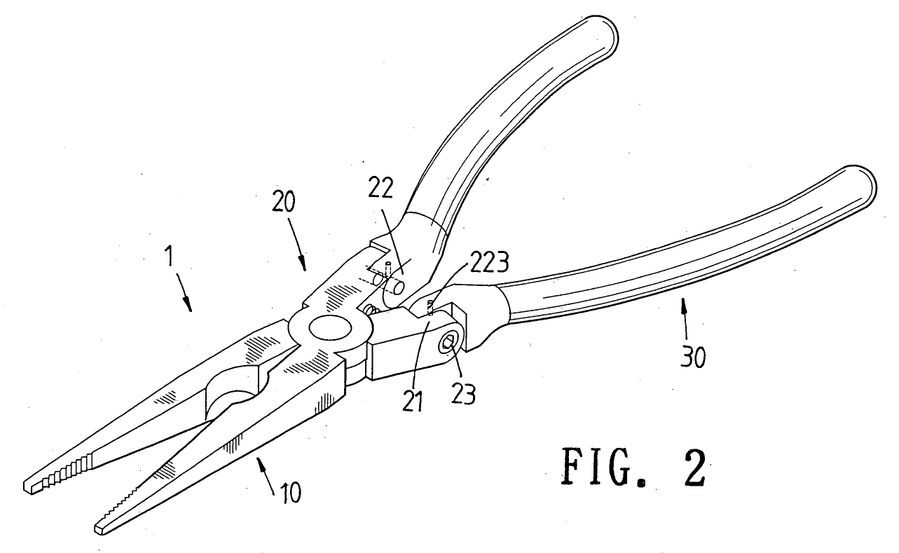

Referring to FIGS. 1 to 3, the pivotal retaining device of a hand tool of the present invention is illustrated. In the following, a pliers is used as an example. The pivotal retaining device of a hand tool has the following elements.

A tool body 1 comprises the following components.

A clamping portion 10 has an opening which can be opened or closed.

A handle portion 30 serves for being held by users.

A pivotal portion 20 has two first pivotal blocks 21 at distal ends of the clamping portion 10 and two second pivotal blocks 22 at front ends of the handle portion 30. Each first pivotal block 21 has a respective first through hole 211.

Each second pivotal block 22 has a respective screw hole 221 positioned corresponding to a respective one of the through holes 211. Each second pivotal block 22 has a positioning hole 222 which communicates into the screw hole 221 from an axial direction of the screw hole 221. A pin 223 inserts into the positioning hole 222.

The pivotal portion 20 has two retaining shafts 23. Each retaining shaft 23 has a thread portion 231 at a front end thereof. Each retaining shaft 23 inserts through the through hole 211 of a respective first pivotal block 21 and the respective positioning hole 222 of a respective second pivotal block 22 so as to fix the first pivotal block 21 to the second pivotal block 22. The thread portion 231 of each retaining shaft 23 has an insertion hole 232. The pin 223 passing through the positioning hole 222 further inserts through the retaining shaft 23. Thus the first pivotal block 21 is firmly secured to the respective second pivotal block 22.

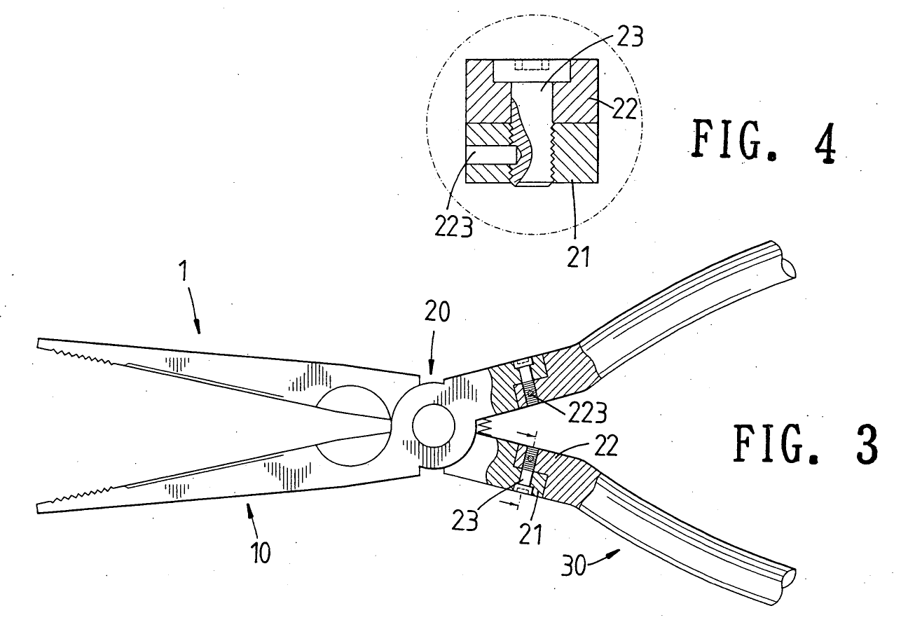

Referring to FIGS. 3 and 4, in assembly of the present invention, the first pivotal blocks 21 of the clamping portion 10 of the tool body 1 are adhered to the second pivotal blocks 22 of the handle portion 30. The through holes 211 of the first pivotal blocks 21 are communicated to respective screw holes 211 of the second pivotal blocks 22. The retaining shafts 23 pass through the through holes 211 of the clamping portion 10 and the thread portions 231 of the retaining shafts 23 are screwed into the screw holes 221 of the second pivotal blocks 22. Then the pins 223 are inserted into the screw holes 221 of the second pivotal blocks 22 and front ends of the pins 223 are inserted into the insertion holes 232 of the retaining shafts 23 at the front end thereof (referring to FIG. 4). In the assembly, the thread portions 231 of the retaining shafts 23 are not in contact with the through holes 211 of the first pivotal blocks 21. The pins 223 are tightly attached to the positioning holes 222. Thus the retaining shafts 23 are tightly fixed to the screw holes 221 without rotation.

In use of the present invention, since the thread portions 231 of the retaining shafts 23 are not in contact with the through holes 211 of the first pivotal blocks 21, the clamping portion 10 is rotatable with respect to the retaining shafts 23. Furthermore, since the thread portions 231 at the front section of the retaining shafts 23 are screwed to the screw holes 221 of the handle portion 30 and are fixed by the pins 232 in the insertion holes 232 of the thread portions 231, the retaining shafts 23 will not rotate with respect to the tool body 1 to be released. Thus, the retaining shafts 23 will not fall out.

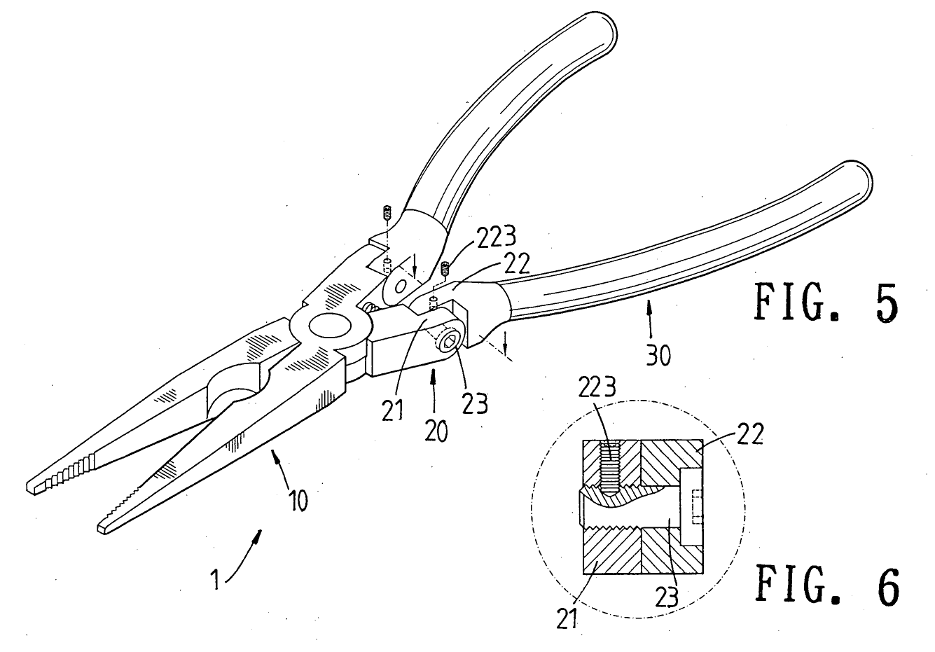

Referring to FIGS. 5 and 6, the second embodiment of the present invention is illustrated. The difference of this embodiment from the above one is that pins 223 has threads and the interiors of the positioning holes 222 are also threaded so that the pins 223 are threaded into the positioning holes 222. Thereby by screwing out the pins 223, the handle portion 30 can be detached from the tool body 1.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. The pivotal retaining device comprising:
a clamping portion;
a handle portion;
a pivotal portion having at least one first pivotal blocks at a distal end of the clamping portion and at least one second pivotal block at a front end of the handle portion; each first pivotal block having a respective first through hole;
each second pivotal block having a respective screw hole positioned corresponding to the through hole; each second pivotal block having a positioning hole which communicates into the screw hole; a pin inserting into the positioning hole;
at least one retaining shaft; each retaining shaft inserting through the through hole of a respective first pivotal block and the positioning hole of a second pivotal block so as to fix the first pivotal block to the second pivotal block; each retaining shaft having an insertion hole; the pin passing through the positioning hole further inserting through the insertion hole of the retaining shaft; thus the first pivotal block being firmly secured to the respective second pivotal block.

2. The pivotal retaining device of a hand tool as claimed in claim 1, wherein each retaining shaft has a thread portion at a front end thereof; and the thread portion is inserted into the screw hole of the second pivotal block.

3. The pivotal retaining device of a hand tool as claimed in claim 1, wherein the pin and the insertion hole are threaded so that the pin is screwed into the insertion hole of the retaining shaft, thus, the handle portion is detachable from the clamping portion.

4. The pivotal retaining device comprising:
a clamping portion;
a handle portion;
a pivotal portion having at least one first pivotal blocks at a distal end of the clamping portion and at least one second pivotal block at a front end of the handle portion; each first pivotal block having a respective first screw hole; each first pivotal block having a positioning hole which communicates into the screw hole; a pin inserting into the positioning hole;
each second pivotal block having a respective through hole positioned corresponding to the screw hole;
at least one retaining shaft; each retaining shaft inserting through the through hole of the second pivotal block and the positioning hole of the first pivotal block so as to fix the first pivotal block to the second pivotal block; each retaining shaft having an insertion hole; the pin passing through the positioning hole further inserting through the insertion hole of the retaining shaft; thus the first pivotal block being firmly secured to the respective second pivotal block.

5. The pivotal retaining device of a hand tool as claimed in claim 4, wherein each retaining shaft has a thread portion at a front end thereof; and the thread portion is inserted into the screw hole of the first pivotal block.

6. The pivotal retaining device of a hand tool as claimed in claim 4, wherein the pin and the insertion hole are threaded so that the pin is screwed into the insertion hole of the retaining shaft, thus, the handle portion is detachable from the clamping portion.
